(19) United States
(12) Patent Application Publication
(10) Pub. No.: US 2005/0261002 A1
(43) Pub. Date: Nov. 24, 2005

(54) Tracking method and system to be implemented using a wireless telecommunications network

(75) Inventor: Jerry Cheng, Chung-Ho City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: WINTECRONICS CO., LTD.

(21) Appl. No.: 10/848,117

(22) Filed: May 19, 2004

(51) Int. Cl. H04Q 7/20

(52) U.S. Cl. 455/456.1; 455/456.3; 455/456.2

(57) ABSTRACT

A tracking method for a tracking system that includes target and tracking devices includes the steps of: in response to a location request issued by the tracking device and transmitted through a wireless telecommunications network, enabling operation of the target device to access a location-based service that is provided by the wireless telecommunications network and to generate a location information signal from the location-based service that is subsequently transmitted to the target device through the wireless telecommunications network such that an immediate vicinity of the target device can be located; and, in response to a tracking request from the tracking device, enabling the target device to transmit a beaconing signal wirelessly such that an exact location of the target device can be determined based on the beaconing signal.

### BACKGROUND OF THE INVENTION

1. Field of the Invention

The invention relates to a tracking method and system, more particularly to a tracking method and system to be implemented using a wireless telecommunications network.

2. Description of the Related Art

A conventional tracking system includes target and tracking devices. The target device transmits a beaconing signal through a proprietary wireless surveillance network. The tracking device receives the beaconing signal through the wireless surveillance network, and locates the target device based on the beaconing signal. Although the conventional tracking system achieves its intended purpose, since the target device is powered by a battery, and since the target device transmits the beaconing signal regardless of its position with respect to the tracking device, battery life of the battery may run out even before the tracking device locates the target device. Furthermore, the wireless surveillance network is relatively expensive to implement and maintain.

Another conventional tracking system, which includes target and tracking devices, takes advantage of a location based service (LBS) provided by an existing wireless telecommunications network, such as a global system for mobile communications (GSM) network or a Global Position System (GPS). The wireless telecommunications network requires no added costs when implementing the tracking system. However, the LBS provides the tracking device with only an immediate vicinity of the target device. In other words, the exact location of the target device cannot be obtained by the tracking device from the LBS.

### SUMMARY OF THE INVENTION

Therefore, the object of the present invention is to provide a tracking method and system that permits a tracking device to locate an exact position of a target device.

According to one aspect of the present invention, a tracking method comprises the steps of:
(A) in response to a location request issued by a locating party and transmitted through a wireless telecommunications network, enabling operation of a target device for accessing a location-based service that is provided by the wireless telecommunications network, and generating a location information signal from the location-based service that is subsequently transmitted to the locating party through the wireless telecommunications network; and
(B) in response to a tracking request from the locating party, enabling the target device to transmit a beaconing signal wirelessly.

According to another aspect of the present invention, a tracking system comprises a target device. The target device includes a telecommunications module and a beaconing module. The telecommunications module is responsive to a location request issued by a locating party and transmitted through a wireless telecommunications network, accesses a location-based service that is provided by the wireless telecommunications network, and generates a location information signal from the location-based service that is subsequently transmitted to the locating party through the wireless telecommunications network. The beaconing module is responsive to a tracking request from the locating party, and transmits a beaconing signal wirelessly.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a target device of the preferred embodiment of a tracking system according to the present invention;

FIG. 2 is a schematic circuit block diagram illustrating a tracking device of the preferred embodiment; and

FIG. 3 is a flowchart of the preferred embodiment of a tracking method according to the present invention.

### DETAILED DESCRIPTION OF THE PREFERRED EMBODIMENT

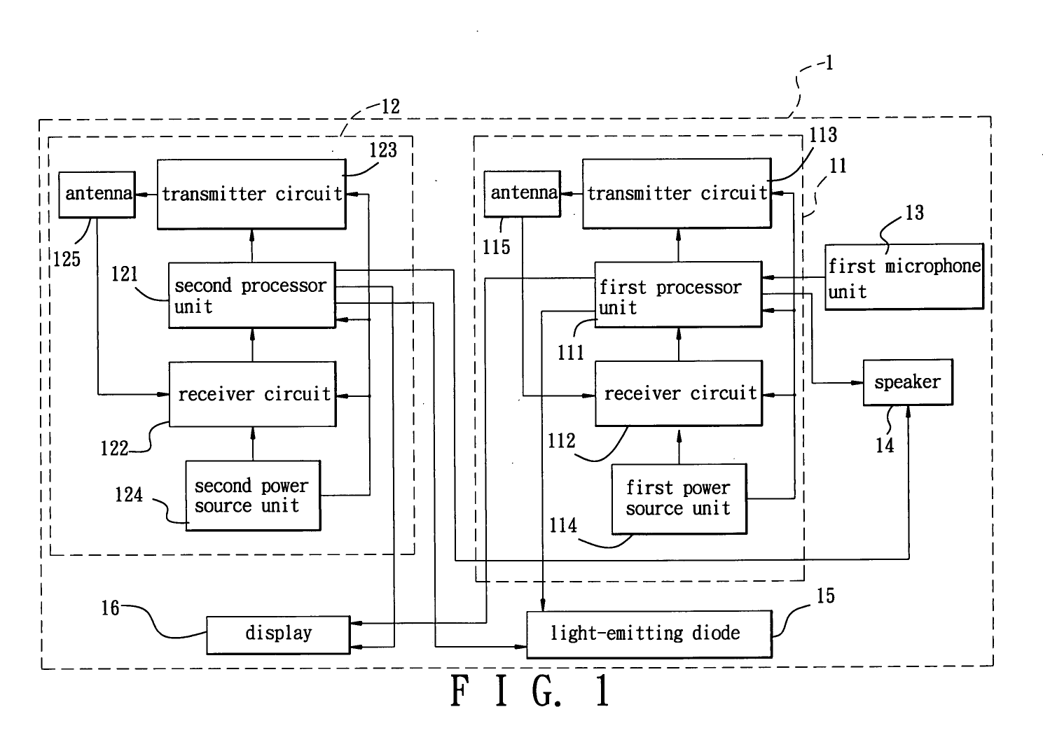

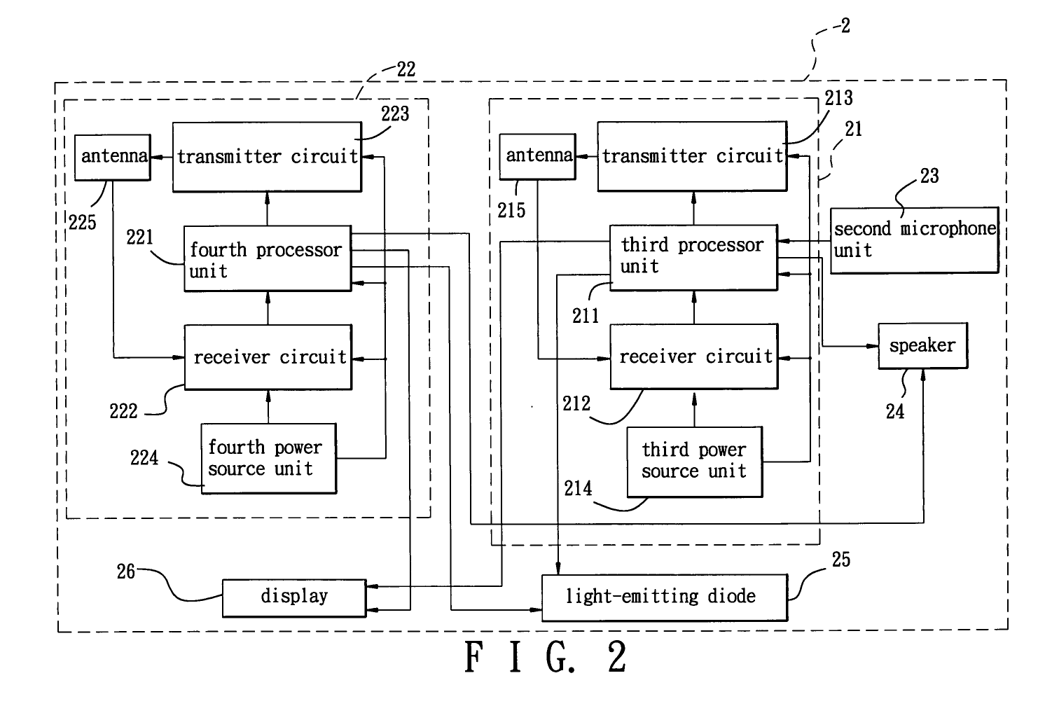

Referring to FIGS. 1 and 2, the preferred embodiment of a tracking system according to this invention is shown to include target and tracking devices 1, 2.

As shown in FIG. 1, the target device 1 includes a first telecommunications module 11 and a beaconing module 12.

The first telecommunications module 11 of the target device 1 is responsive to a location request that is received through a wireless telecommunications network (not shown). The location request is issued by a locating party (not shown) and transmitted through the wireless telecommunications network. The first telecommunications module 11 accesses a location-based service that is provided by the wireless telecommunications network in a known manner, and generates a location information signal from the location-based service that is subsequently transmitted to the locating party through the wireless telecommunications network. Preferably, the location information signal is in a short message service format, and includes a map showing an immediate vicinity of the target device 1.

It is noted that the wireless telecommunications network may be one of a global system for mobile communications (GSM) network, a time division multiple access (TDMA) network, and a code division multiple access (CDMA) network. Furthermore, the location request may be transmitted through a plain old telephone service (POTS) network.

It is also noted that the target device 1 may be stored with numbers associated with mobile phones (not shown) such that the target device 1 is able to dial selected ones of the numbers, upon receipt of the location request, and to transmit the location information signal to the selected mobile phones through the wireless telecommunications network.

It is further noted that, in an alternative embodiment, the location information signal is in a voice mail format. As such, the target device 1 may be stored with numbers associated with telephones (not shown) such that the target device 1 is able to dial selected ones of the numbers, upon receipt of the location request, and transmits the location information signal to the selected telephones through the POTS network.

In this embodiment, the first telecommunications module 11 includes a first processor unit 111, a first transceiver unit coupled to the first processor unit 111, and a first power source unit 114 coupled to the first processor unit 111 and the first transceiver unit. The first transceiver unit includes transmitter and receiver circuits 113, 112, and an antenna 115 coupled to the transmitter and receiver circuits 113, 112. The first processor unit 111 is operable so as to control the transmitter circuit 113 of the first transceiver unit to transmit the location information signal wirelessly. The receiver circuit 112 of the first transceiver unit is operable so as to receive the location request wirelessly. The first processor unit 111 is further operable so as to process the received location request. The first power source unit 114 provides electric power to the first processor unit 111, and the transmitter and receiver circuits 113, 112 of the first transceiver unit.

The beaconing module 12 is responsive to a tracking request from the locating party, and transmits a beaconing signal wirelessly.

In this embodiment, the beaconing module 12 includes a second processor unit 121, a second transceiver unit coupled to the second first processor unit 121, and a second power source unit 124 coupled to the second processor unit 121 and the second transceiver unit. The second transceiver unit includes transmitter and receiver circuits 123, 122, and an antenna 125 coupled to the transmitter and receiver circuits 123, 122. The second processor unit 121 is operable so as to control the transmitter circuit 123 of the second transceiver unit to transmit the beaconing signal wirelessly. The receiver circuit 122 of the second transceiver unit is configured to receive the tracking request wirelessly and directly from the tracking device 1. The second processor unit 121 is further operable so as to process the received tracking request. The second power source unit 124 provides electric power to the second processor unit 121 and the second transceiver unit.

The target device 1 further includes a first microphone unit 13 coupled to the first processor unit 111, and a first indicator unit coupled to the first and second processor units 111, 121. The first indicator unit of the target device 1 includes a speaker 14, a light-emitting diode 15, and a display 16. Preferably, the display 16 of the first indicator unit is a liquid crystal display. It is noted that the light-emitting diode 15 and the display 16 of the first indicator unit may not be necessary in certain applications and, hence, maybe dispensed with.

As shown in FIG. 2, the tracking device 2 includes a second telecommunications module 21 and a beacon tracking module 22.

The second telecommunications module 21 of the tracking device 2 is operated by the locating party to generate the location request and to receive the location information signal transmitted by the target device 1. In particular, when issuing the location request, the second telecommunications module 21 of the tracking device is operated so as to dial a number associated with the target device 1.

In this embodiment, the second telecommunications module 21 includes a third processor unit 211, a third transceiver unit coupled to the third processor unit 211, and a third power source unit 214 coupled to the third processor unit 211 and the third transceiver unit. The third transceiver unit includes transmitter and receiver circuits 213, 212, and an antenna 215 coupled to the transmitter and receiver circuits 213, 212. The third processor unit 211 of the third transceiver unit is operable so as to control the transmitter circuit 213 to transmit the location request wirelessly. The receiver circuit 212 of the third transceiver unit is operable so as to receive the location information signal wirelessly. The third processor unit 211 is further operable so as to process the received location information signal. The third power source unit 214 provides electric power to the third processor unit 211 and the third transceiver unit.

The beacon tracking module 22 of the tracking device is operated by the locating party to generate the tracking request, and to receive the beaconing signal directly and wirelessly from the beaconing module 12 of the target device 1.

It is noted that the beaconing module 12 of the target device 1 and the beacon tracking module 22 of the tracking device 2 are able to receive the tracking request and the beaconing signal, respectively, only when the tracking device 2 is within the vicinity of the target device 1.

Preferably, the beaconing module 12 is activated to begin transmission of the beaconing signal only upon receipt of the tracking request from the tracking device 2. As such, battery life of the second power source unit 124 of the beaconing module 12 can be extended.

In this embodiment, the beacon tracking module 22 includes a fourth processor unit 221, a fourth transceiver unit coupled to the fourth processor unit 221, and a fourth power source unit 224 coupled to the fourth processor unit 221 and the fourth transceiver unit. The fourth transceiver unit includes transmitter and receiver circuits 223, 222, and an antenna 225 coupled to the transmitter and receiver circuits 223, 222. The fourth processor unit 221 is operable so as to control the transmitter circuit 223 of the third transceiver unit to transmit the tracking request wirelessly. The receiver circuit 222 of the fourth transceiver unit is operable so as to receive the beaconing signal wirelessly. The fourth processor unit 221 is further operable so as to process the received beaconing signal. The fourth power source unit 224 provides electric power to the fourth processor unit 221 and the fourth transceiver unit. It is noted that the beaconing module 12 of the target device 1 and the beacon tracking module 22 of the tracking device 1 have an operating frequency different from that of the first telecommunications module 11 of the target device 1 and the second telecommunications module 21 of the tracking device 2.

The tracking device 2 further includes a second microphone unit 23 coupled to the third processor unit 211, and a second indicator unit coupled to the third and fourth processor units 211, 221. The second indicator unit of the tracking device 2 includes a speaker 24, a light-emitting diode 25, and a display 26. Preferably, the display 26 of the second indicator unit is a liquid crystal display.

It is noted that, in this embodiment, when the first telecommunications module 11 and the beaconing module 12 of the target device 1 are activated and deactivated, respectively, the first microphone unit 13 and the first indicator unit are controlled by the first processor unit 111. At this time, the first indicator unit is controlled by the first processor unit 111 to indicate operating status of the target device 1, and the first telecommunications module 11 of the target device 1 may be operated as a mobile phone. On the other hand, when the beaconing module 12 of the target device 1 is activated, the first indicator unit is controlled by the second processor unit 121. At this time, the first indicator unit is controlled by the second processor unit 121 to indicate operating status of the target device 1, and the beaconing module 12 of the target device 1 is operated so as to transmit the beaconing signal.

It is also noted that, in this embodiment, when the second telecommunications module 21 and the beacon tracking module 22 of the tracking device 2 are activated and deactivated, respectively, the second microphone unit 23 and the second indicator unit are controlled by the third processor unit 211. At this time, the second indicator unit is controlled by the third processor unit 211 to indicate operating status of the tracking device 2, and the second telecommunications module 21 of the tracking device 2 may be operated as a mobile phone. On the other hand, when the beacon tracking module 22 of the tracking device 2 is activated, the second indicator unit is controlled by the fourth processor unit 221. At this time, the second indicator unit is controlled by the fourth processor unit 221 to indicate proximity of the tracking device 2 relative to the target device 1 based on strength of the beaconing signal received by the beacon tracking module 22. As such, the tracking device 2 can be used to locate an exact position of the target device 1.

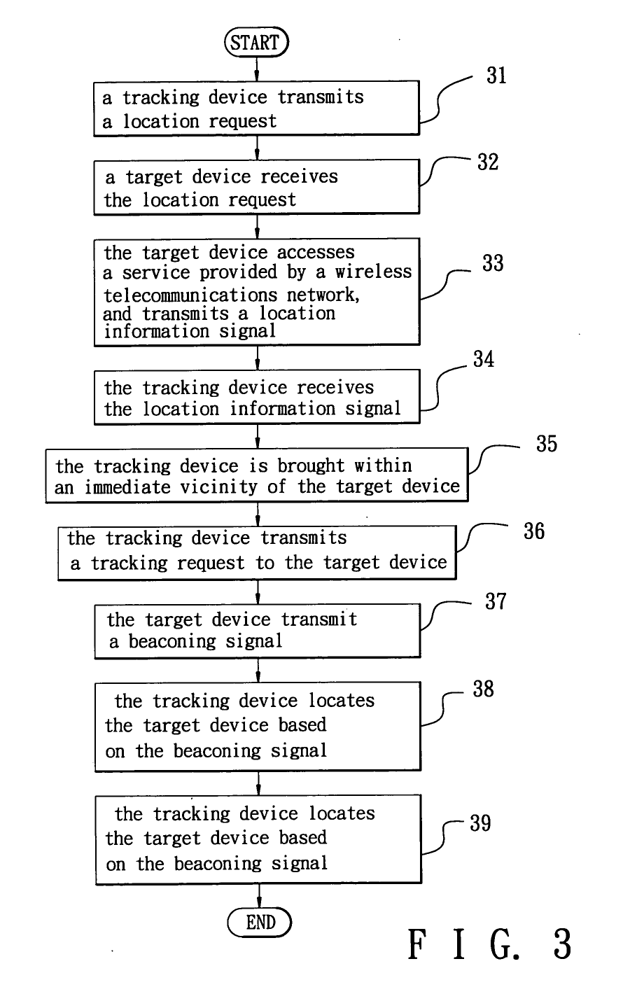

The preferred embodiment of the tracking method according to this invention comprises the steps shown in FIG. 3.

In step 31, the tracking device 2 is operated by the locating party to transmit the location request through the wireless telecommunications network.

In step 32, the target device 1 receives the location request through the wireless telecommunications network.

In step 33, in response to the location request from the locating party, the target device 1 is enabled to access the location-based service that is provided by the wireless telecommunications network, and to generate a location information signal from the location-based service that is subsequently transmitted to the locating party through the wireless telecommunications network.

In step 34, the tracking device 2 receives the location information signal through the wireless telecommunications network.

In step 35, the tracking device 2 is brought by the locating party within the immediate vicinity of the target device 1 with reference to the location information signal.

In step 36, the tracking device 2 is operated by the locating party to transmit the tracking request directly and wirelessly to the target device 1.

In step 37, in response to the tracking request from the locating party, the target device 1 is enabled to transmit the beaconing signal wirelessly.

In step 38, the tracking device 2 receives the beaconing signal.

In step 39, the tracking device 2 indicates the proximity thereof relative to the target device 1 based on strength of the beaconing signal received from the target device 1, thereby permitting the locating party to locate the exact position of the target device 1 through the tracking device 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A tracking method, comprising the steps of:
(A) in response to a location request issued by a locating party and transmitted through a wireless telecommunications network, enabling operation of a target device for
accessing a location-based service that is provided by the wireless telecommunications network, and
generating a location information signal from the location-based service that is subsequently transmitted to the locating party through the wireless telecommunications network; and
(B) in response to a tracking request from the locating party, enabling the target device to transmit a beaconing signal wirelessly.

2. The tracking method as claimed in claim 1, wherein, in step (A), the target device receives the location request through the wireless telecommunications network.

3. The tracking method as claimed in claim 1, wherein, in step (A), the location request is generated using a tracking device operated by the locating party.

4. The tracking method as claimed in claim 3, wherein the tracking device is operated to dial a number associated with the target device when issuing the location request.

5. The tracking method as claimed in claim 1, wherein, in step (A), the location information signal is to be received by a tracking device operated by the locating party.

6. The tracking method as claimed in claim 5, wherein the location information signal is in a short message service format.

7. The tracking method as claimed in claim 6, wherein the location information signal includes a map showing an immediate vicinity of the target device.

8. The tracking method as claimed in claim 1, wherein, in step (B), the tracking request is generated using a tracking device operated by the locating party.

9. The tracking method as claimed in claim 8, wherein, in step (B), the target device is activated to begin transmission of the beaconing signal only upon receipt of the tracking request from the tracking device.

10. The tracking method as claimed in claim 9, wherein the target device receives the tracking request directly and wirelessly from the tracking device.

11. The tracking method as claimed in claim 1, wherein, in step (B), the beaconing signal is received by a tracking device operated by the locating party.

12. The tracking method as claimed in claim 11, wherein the tracking device receives the beaconing signal directly and wirelessly from the target device.

13. The tracking method as claimed in claim 11, wherein the tracking device is capable of indicating proximity thereof relative to the target device based on strength of the beaconing signal received from the target device.

14. A tracking system, comprising a target device that includes:
a telecommunications module, responsive to a location request issued by a locating party and transmitted through a wireless telecommunications network, for accessing a location-based service that is provided by the wireless telecommunications network, and for generating a location information signal from the location-based service that is subsequently transmitted to the locating party through the wireless telecommunications network; and
a beaconing module, responsive to a tracking request from the locating party, for transmitting a beaconing signal wirelessly.

15. The tracking system as claimed in claim 14, wherein said telecommunications module receives the location request through the wireless telecommunications network.

16. The tracking system as claimed in claim 14, further comprising a tracking device to be operated by the locating party for generating the location request.

17. The tracking system as claimed in claim 16, wherein said tracking device includes a telecommunications module which is operable so as to dial a number associated with said target device when issuing the location request.

18. The tracking system as claimed in claim 14, further comprising a tracking device operated by the locating party for receiving the location information signal transmitted by said target device.

19. The tracking system as claimed in claim 18, wherein the location information signal is in a short message service format.

20. The tracking system as claimed in claim 19, wherein the location information signal includes a map showing an immediate vicinity of the target device.

21. The tracking system as claimed in claim 14, further comprising a tracking device operated by the locating party for generating the tracking request.

22. The tracking system as claimed in claim 21, wherein said beaconing module is activated to begin transmission of the beaconing signal only upon receipt of the tracking request from said tracking device.

23. The tracking system as claimed in claim 22, wherein said beaconing module is configured to receive the tracking request directly and wirelessly from said tracking device.

24. The tracking system as claimed in claim 14, further comprising a tracking device operated by the locating party for receiving the beaconing signal.

25. The tracking system as claimed in claim 24, wherein said tracking device includes a beacon tracking module for receiving the beaconing signal directly and wirelessly from said beaconing module of said target device.

26. The tracking system as claimed in claim 24, wherein said tracking device further includes indicator means for indicating proximity of said tracking device relative to said target device based on strength of the beaconing signal received by said beacon tracking module.
